(19) United States
(12) Patent Application Publication
(10) Pub. No.: US 2018/0364387 A1
(43) Pub. Date: Dec. 20, 2018

(54) FOREIGN OBJECT DETECTION SENSOR

(71) Applicant: Aisin Seiki Kabushiki Kaisha, Kariya-shi (JP)

(72) Inventors: Wataru HATTORI, Okazaki-shi (JP); Ryujiro Akizuki, Kariya-shi (JP); Yuki Osaki, Obu-shi (JP)

(73) Assignee: Aisin Seiki Kabushiki Kaisha, Kariya-shi (JP)

(21) Appl. No.: 16/008,519

(22) Filed: Jun. 14, 2018

(30) Foreign Application Priority Data
Jun. 20, 2017 (JP) 2017-120614

(51) Int. Cl. G01V 3/02

(52) U.S. Cl. CPC G01V 3/02

(57) ABSTRACT

A foreign object detection sensor includes an outer cover formed in a longitudinal hollow shape, the outer cover including an insulating property and an elasticity, the outer cover including an attachment portion at an outer surface, a first electrode and a second electrode each including a conductivity and the elasticity, the first electrode and the second electrode extending along a longitudinal direction of the outer cover in a state of being spaced apart from each other inside the outer cover, the second electrode being disposed at a position away from the attachment portion relative to the first electrode, the second electrode including a coefficient of elasticity lower than the first electrode, and the first electrode and the second electrode detecting a foreign object by coming in contact with each other in accordance with an elastic deformation of the outer cover by a pressurizing force from the foreign object.

### CROSS REFERENCE TO RELATED APPLICATIONS

This application is based on and claims priority under 35 U.S.C. § 119 to Japanese Patent Application 2017-120614, filed on Jun. 20, 2017, the entire content of which is incorporated herein by reference.

### TECHNICAL FIELD

This disclosure generally relates to a foreign object detection sensor.

### BACKGROUND DISCUSSION

A known foreign object detection sensor of this kind is used in an electric opening and closing device opening and closing an opening portion formed at a vehicle body by an electric opening and closing body, and detects a catch of a foreign object that is between a circumferential rim portion of the opening portion and the opening and closing body. For example, JP2013-247080A (hereinafter referred to as Patent Reference 1) discloses a foreign object detection sensor including a longitudinal hollow insulator (outer cover) including a band-shaped attachment portion being mounted on the circumferential rim portion of the opening portion or a circumferential rim portion of the opening and closing body at an outer surface of the hollow insulator, and a pair of electrode wires extending along the hollow insulator in a longitudinal direction in a state of being spaced apart from each other inside the hollow insulator. The foreign object detection sensor detects the foreign object by that the hollow insulator is pressurized by receiving an outer force from the foreign object, and that the pair of electrode wires comes in contact with each other and causes conduction (short-circuit) in accordance with the pressurization of the follow insulator. The pair of electrode wires each is configured by a conductive rubber extending along the longitudinal direction of the hollow insulator, and a conductive wire embedded inside the conductive rubber. The conductive wire is formed by conductive thin wires made from a metal material and twisted together, and to be meandered in a wave form (sinusoidal shape) from a first end to a second end in the longitudinal direction. Accordingly, because the conductive rubber is not inhibited from being bent relative to the longitudinal direction by the conductive wire, the foreign object detection sensor may be easily bent in the longitudinal direction even in a case of being mounted on a place including a corner portion, and the mountability of the foreign object detection sensor is enhanced. The foreign object detection sensor is formed by an extrusion molding method.

The foreign object detection sensor formed by the extrusion molding method is manufactured such that the pair of conductive wires is lead to a crosshead of an extruding machine and the material is extruded to cover the circumference of the pair of electrode wires at the crosshead to form the pair of electrode wires, and the material is extruded and covered on each of outer circumferences of the pair of conductive wires to form the outer cover, and a molded component is drawn or picked up by a haul-off device via a cooling tank. In the foreign object detection sensor disclosed in Patent reference 1, because the conductive wire is meandered in the wave shape, the material is covered in a state where the conductive wire is stretched when a tensile force is applied to the conductive wire on the drawing or pickup process. Thus, in the technology disclosed in Patent reference 1, it is difficult to cover the material while the wave form of the conductive wire is maintained by using the extrusion molding method, and the manufacturing cost may increase.

A need thus exists for a foreign object detection sensor which is not susceptible to the drawback mentioned above.

### SUMMARY

According to an aspect of this disclosure, a foreign object detection sensor includes an outer cover formed in a longitudinal hollow shape, the outer cover including an insulating property and an elasticity, the outer cover including an attachment portion at an outer surface, a first electrode and a second electrode each including a conductivity and the elasticity, the first electrode and the second electrode extending along a longitudinal direction of the outer cover in a state of being spaced apart from each other inside the outer cover, the second electrode being disposed at a position away from the attachment portion relative to the first electrode, the second electrode including a coefficient of elasticity lower than the first electrode, and the first electrode and the second electrode detecting a foreign object by coming in contact with each other in accordance with an elastic deformation of the outer cover by a pressurizing force from the foreign object.

### BRIEF DESCRIPTION OF THE DRAWINGS

The foregoing and additional features and characteristics of this disclosure will become more apparent from the following detailed description considered with the reference to the accompanying drawings, wherein:

FIGS. 1A and 1B are outline drawings of a vehicle according to an embodiment disclosed here;

FIG. 2 is a cross sectional view taken along line II-II in FIG. 1;

FIG. 3 is a cross sectional view of a foreign object detection sensor;

FIG. 4 is a view schematically illustrating a second conductive wire;

FIGS. 5A and 5B are explanatory views illustrating a curvature of a conductive wire; and

FIG. 6 is a view schematically illustrating an extrusion molding machine.

### DETAILED DESCRIPTION

An embodiment of this disclosure will hereunder be explained with reference to the drawings.

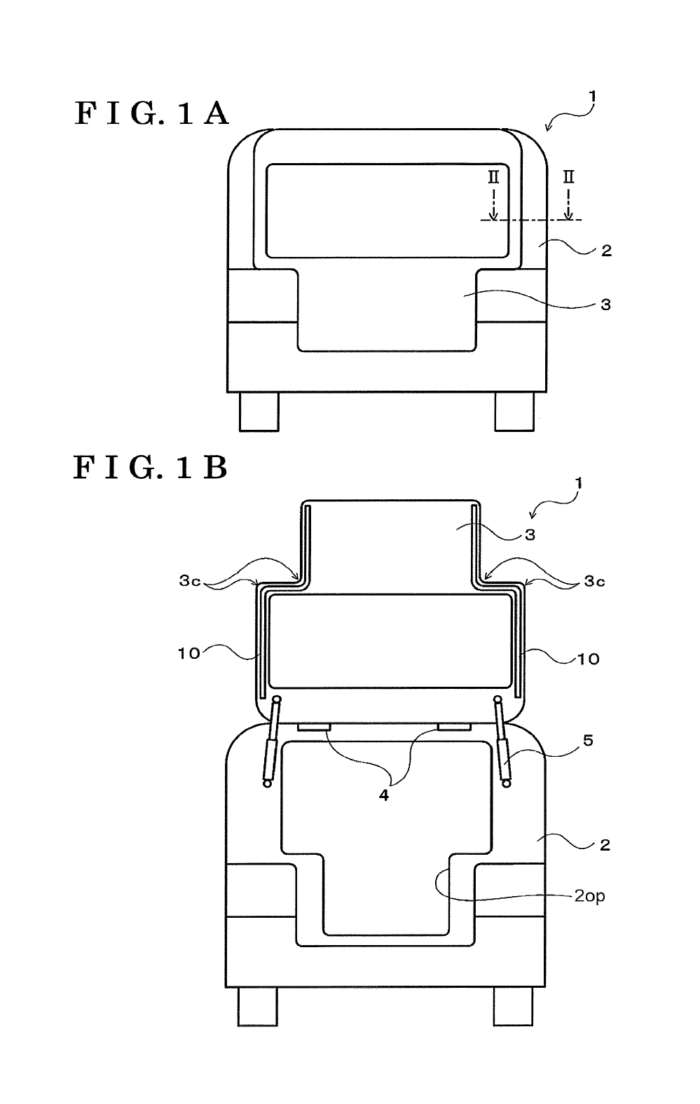

As illustrated in FIGS. 1A and 1B, a vehicle 1 includes a vehicle body 2 provided with an opening portion 2op at a rear portion, a door panel (a backdoor panel) 3 mounted on the vehicle body 2 so as to cover the opening portion 2op, and an electric door opening and closing device 5 that is provided between the vehicle body 2 and the door panel 3 and that opens and closes the opening portion 2op by moving the door panel 3 with an actuator. In the embodiment, the door panel 3 is configured as a flap door of which an upper end portion is connected to an upper end portion of the rear portion of the vehicle body 2 via hinges 4, and of which a lower end portion rotates in an upper and lower direction by the hinges 4 each serving as a fulcrum point.

As illustrated in FIG. 1B, the opening portion 2op of the vehicle body 2 is formed such that a length of an upper portion in the right-left direction is wider than a length of a lower portion.

As illustrated in FIG. 1B, the door panel 3 is formed such that a length of an upper portion in the right-left direction is wider than a length of a lower portion to support the opening portion 2op, and includes two corner portions 3c bending substantially at a right angle at each of both ends portions in the right-left direction. A circumferential rim portion of the door panel 3 includes a foreign object detection portion 10 detecting the catch of a foreign object between the circumferential rim portion of the door panel 3 and a circumferential rim portion of the opening portion 2op of the vehicle body 2.

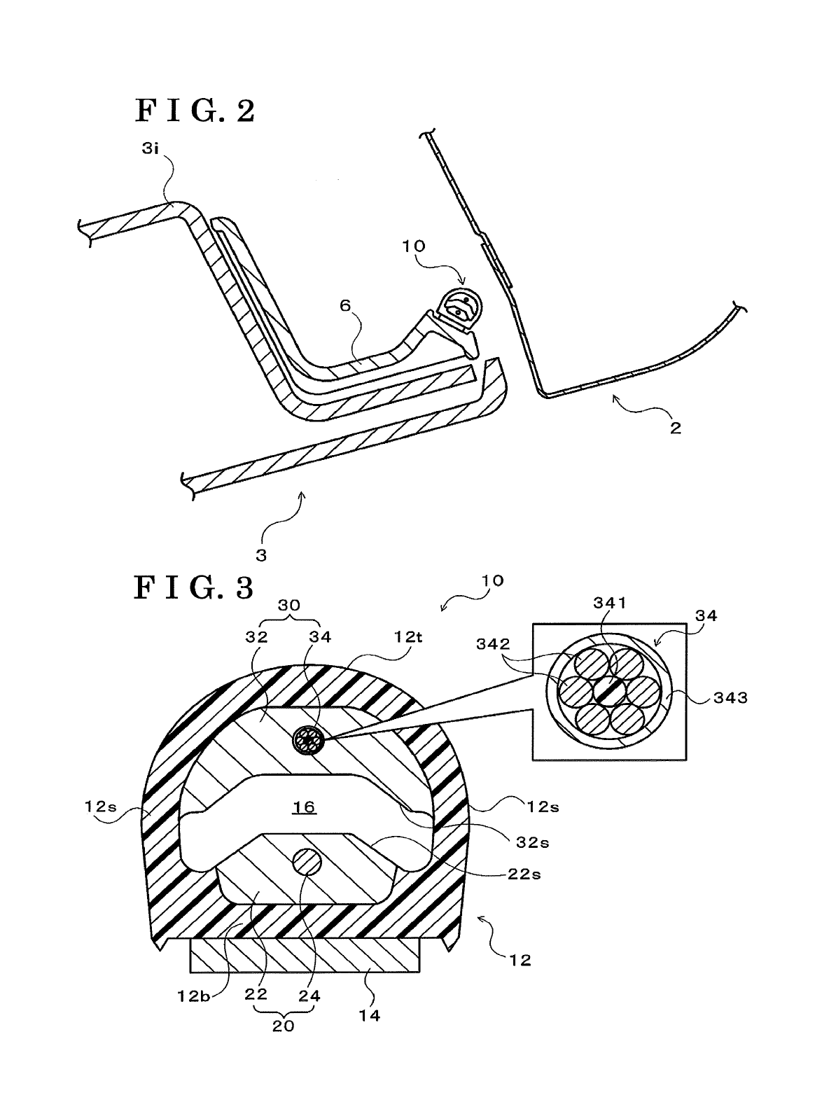

The foreign object detection sensor 10 corresponds to a longitudinal string member having an elasticity, and as shown in FIG. 2, is fixed at both end portions of an inner panel 3i (a panel at a side of a vehicle compartment) of the door panel 3 in the right-left direction via a bracket 6. The bracket 6 is a longitudinal member extending in the upper-lower direction at each of the end portions of the door panel 3 in the right-left direction, and bends along the corner portion 3c provided at the door panel 3. The foreign object detection sensor 10 is attached to the bracket 6 in a state of bending along the curvature of the bracket 6 by a double-sided adhesive tape.

As illustrated in FIG. 3, the foreign object detection sensor 10 includes an outer cover 12, a first electrode wire 20 (i.e., serving as a first electrode) and a second electrode wire 30 (i.e., serving as a second electrode). The outer cover 12 is made from an insulating material (for example, a soft resin member), is formed in a longitudinal cylindrical shape, and is elastically deformable. The first electrode wire 20 and the second electrode wire 30 are disposed inside the outer cover 12 and extend in a parallel manner while having a predetermined clearance 16 therebetween along the longitudinal direction of the outer cover 12.

The outer cover 12 corresponds to a longitudinal cylindrical body having a cross section which is formed in a substantially D shape, and includes a bottom portion 12b, a pair of side portions 12s, and a top portion 12t. The bottom portion 12b includes a band-shaped attachment portion 14 (an attachment surface) provided at an outer surface of the outer cover 12 and attached to the bracket 6. The side portions 12s are standingly provided at both sides of the bottom portion 12b. The top portion 12t connects upper ends of the pair of side portions 12s to be formed in an arc shape.

The first electrode wire 20 includes a first conductive rubber 22 (i.e., serving as a first conductive elastic body) and a first conductive wire 24. The first conductive rubber 22 includes conductivity and elasticity, and extends along the longitudinal direction of the outer cover 12. The first conductive wire 24 is embedded inside the first conductive rubber 22 and extends along the extending direction of the first conductive rubber 22. The first conductive rubber 22 is disposed at an inner surface of the bottom portion 12b of the outer cover 12. In the embodiment, the first conductive wire 24 is formed as a solid wire, or a single wire, made by, for example, copper.

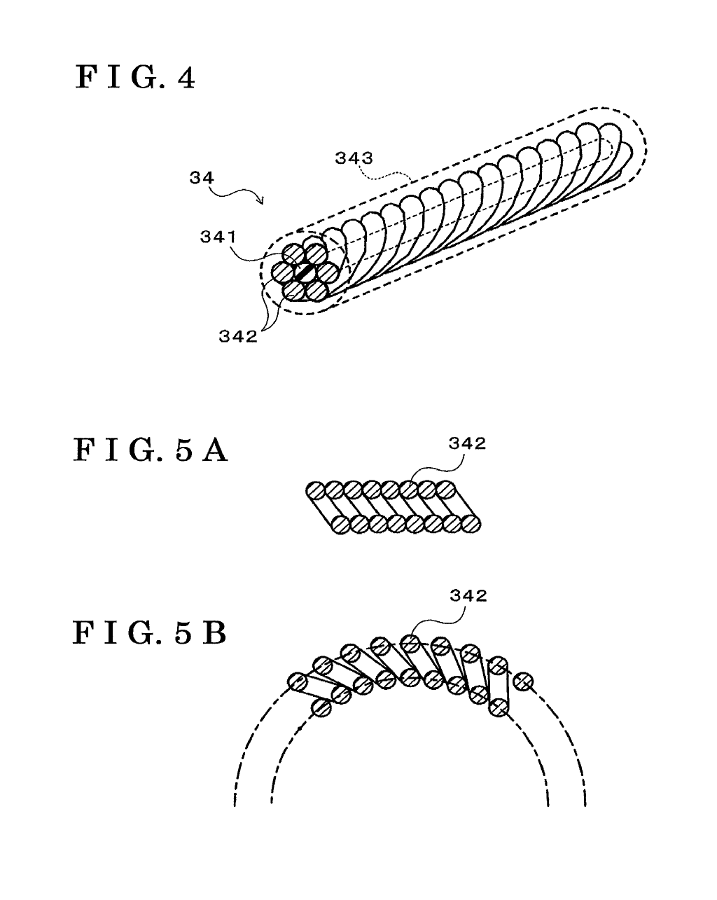

The second electrode wire 30 includes a second conductive rubber 32 (i.e., serving as a second conductive elastic body) and a second conductive wire 34. The second conductive rubber 32 includes conductivity and elasticity and extends along the longitudinal direction of the outer cover 12. The second conductive wire 34 is embedded inside the second conductive rubber 32 and extends along the extending direction of the second conductive rubber 32. The second conductive rubber 32 is disposed at an inner surface of the top portion 12t of the outer cover 12. The second conductive rubber 32 is formed so as to decrease the elasticity relative to the first conductive rubber 22. In the embodiment, the second conductive rubber 32 is formed as a rubber foam body including the conductivity. The second conductive wire 34 is formed to decrease the elasticity relative to the first conductive rubber 22. As shown in FIG. 4, the second conductive wire 34 includes a string-shaped core material 341, plural conductive wires 342, and a conductive fiber 343. The core material 341 includes elasticity (flexibility) of, for example, a rubber. The plural conductive wires 342 wind around the core material 341 in a spiral manner. The conductive fiber 343 covers the core material 341 and the plural conductive wires 342. The conducive wires 342 in the embodiment correspond to a stranded wire formed by plural conductive thin wires (for example, flexible silver coating conductive wires) being twisted together. As such, because of being configured such that the core material 341 having elasticity is wound with the plural conductive wires 342, the second conductive wire 34 may be easily bent as illustrated in FIG. 5.

A first end of the first conductive wire 24 and a first end of the second conductive wire 34 are connected with each other via a resistor. A second end of the first conductive wire 24 is connected to a ground (grounded or earthed to the vehicle body 2), and a second end of the second conductive wire 34 is connected to a detection circuit. The detection circuit applies electric current to the first conductive wire 24, and detects resistance values between the first conductive wire 24 and the second conductive wire 34. Normally, the first electrode wire 20 (the first conductive rubber 22) and the second electrode wire 30 (the second conductive rubber 32) are disposed away from each other, and the electric current applied to the first conductive wire 24 of the first electrode wire 20 flows to the second conductive wire 34 of the second electrode wire 30 via the resistor. Meanwhile, in a case where the outer cover 12 is pressurized, and the first electrode wire 20 (the first conductive rubber 22) and the second electrode wire 30 (the second conductive rubber 32) come in contact with each other, the first conductive wire 24 and the second conductive wire 34 are electrically short-circuited, and the electric current applied to the first conductive wire 24 flows to the second conductive wire 34 while not being through the resistor. Thus, detecting the change of resistance values between the first conductive wire 24 and the second conductive wire 34 by the detection circuit, the foreign object detection sensor 10 may detect the foreign object. In a case where the foreign object is removed from the foreign object detection sensor 10, because the shape of the outer cover 12 is elastically restored, and the first electrode wire 20 and the second electrode wire 30 are also spaced apart from each other by being elastically restored in accordance with the elastic restoration of the outer cover 12, the foreign object detection sensor 10 may be returned to a normal state of not detecting the foreign object.

In the foreign object detection sensor 10 being configured as above, the first conductive wire 24 is formed as the solid wire, the second conductive wire 34 is formed such that the core material 341 including flexibility is wound with the conductive wires 342, and the second conductive wire 34 includes a coefficient of elasticity lower than the first conductive wire 24. Accordingly, because the bending deformation force is applied to the outer cover 12 about the first conductive wire 24 that serves as a center axis, the second conductive wire 34 may be favorably contracted and extended in accordance with the bending deformation of the outer cover 12. Thus, the foreign object detection sensor 10 may be easily bent while maintaining the clearance 16 between the first electrode wire 20 and the second electrode wire 30 in a case of being mounted so as to be positioned along the corner portion 3c of the door panel 3, and the mountability thereof may be enhanced. Because the second conductive wire 34 including the coefficient of elasticity lower than the first conductive wire 24 is disposed at the inner surface of the top portion 12t that is disposed opposite to the bottom portion 12b (the mounting portion 14) of the outer cover 12, the first conductive rubber 22 and the second conductive rubber 32 may come in contact with each other by being easily and elastically deformed when outer force is applied to the top portion 12t, and the detection sensitivity of the foreign object detection sensor 10 may be enhanced.

As illustrated in FIG. 3, the foreign object detection sensor 10 is configured such that a first opposing surface 22s of the first conductive rubber 22 that faces the second conductive rubber 32 is formed in a protruding shape, a second opposing surface 32s of the second conductive rubber 32 that faces the first conductive rubber 22 is formed in a recessed shape, and the clearance 16 between the first conductive rubber 22 and the second conductive rubber 32 is formed in an inverted-V shape, or in a substantially inverted-V shape. Accordingly, in a case where the outer force from the foreign object is applied from either the top portion 12t or the side portion 12s, the first conductive rubber 22 and the second conductive rubber 32 easily come in contact with each other, and the foreign object detection sensor 10 may securely detect the foreign object. Alternatively, each of the first surface 22s of the first conductive rubber 22 and the second surface 32s of the second conductive rubber 32 may be formed in a flat surface.

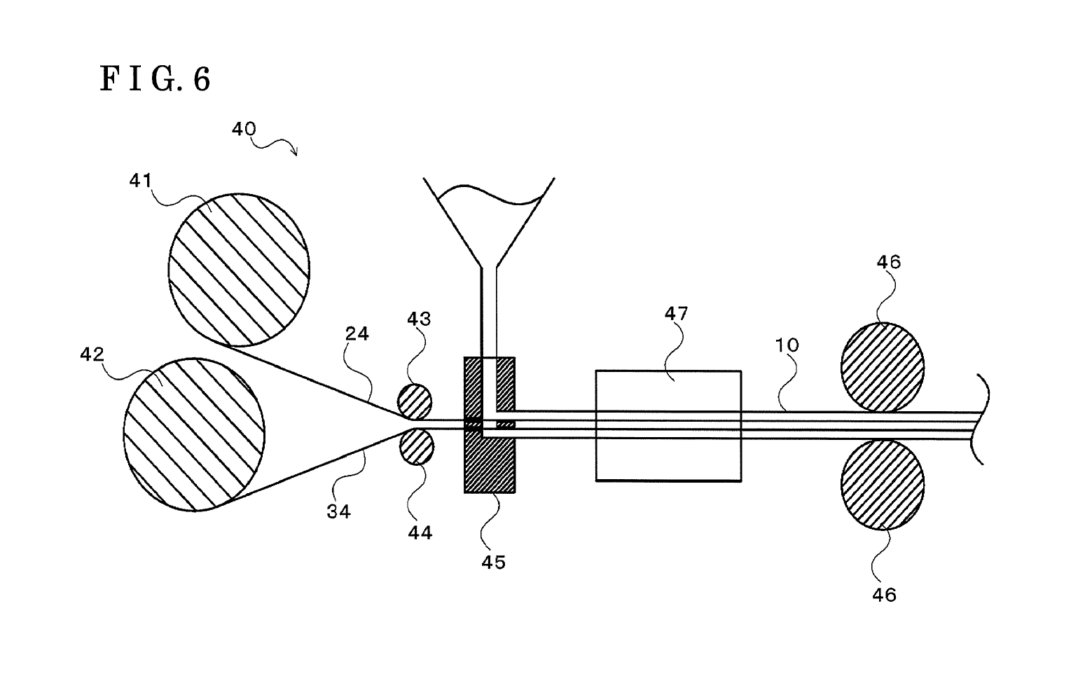

Here, the foreign object detection sensor 10 is manufactured by an extrusion molding device 40 illustrated in FIG. 6. As shown in FIG. 6, the extrusion molding device 40 includes a first delivery device 41, a second delivery device 42, a first tension roller 43, a second tension roller 44, an extruder 45, a haul-off device 46, and a cooling tank 47. The first delivery device 41 delivers the first conductive wire 24. The second delivery device 42 delivers the second conductive wire 34. The first tension roller 43 applies tension to the first conductive wire 24 delivered by the first delivery device 41. The second tension roller 44 applies tension to the second conductive wire 34 by the second delivery device 42. The extruder 45 includes a crosshead that forms the first electrode wire 20 and the second electrode wire 30 by extruding and covering a material (conductive rubber material) on the outer circumferences of the first conductive wire 24 and the second conductive wire 34, respectively, to form the outer cover 12. The haul-off device 46 hauls a molded component. The cooling tank 47 is disposed between the extruder 45 and the haul-off device 46 and cools the molded component. In the embodiment, because of being formed as the solid wire extending linearly, the second conductive wire 34 may receive a tensile force applied on the molding component on the haul-off process thereof by the haul-off device 46. Accordingly, because the material may be covered on the first conductive wire 24 without the extension thereof, the first conductive wire 24 including the coefficient of elasticity lower than the second conductive wire 34, the foreign object detection sensor 10 that may be easily bent and that may include high mountability may be manufactured by the extrusion molding device 40 at low cost.

In the foreign object detection sensor 10 of the embodiment explained as above, because the second electrode wire 30 disposed away from the attachment portion 14 includes the coefficient of elasticity lower than the first electrode wire 20, the second electrode wire 30 may be favorably contracted and extended in accordance with the bending deformation about the first electrode wire 20 that serves as the center axis. Thus, the foreign object detection sensor 10 may be easily bent when being mounted on the door panel 3 including the corner portions 3c, and the mountability of the foreign object detection sensor 10 may be enhanced. Being disposed away from the mounting portion 14 relative to the first electrode wire 20, the second electrode wire 30 may be easily and elastically deformed and come in contact with the first electrode wire 20 in accordance with the elastic deformation of the outer cover 12 by the outer force from the foreign object, and the detection sensitivity of the foreign object detection sensor 10 may be further enhanced. In addition, the first electrode wire 20 disposed in the vicinity of the mounting portion 14 includes the coefficient of elasticity greater than the second electrode wire 30, and may receive the tensile force on the haul-off process, the foreign object detection sensor 10 may be easily manufactured by the extrusion molding process. As a result, the foreign object detection sensor 10 that may include high mountability, that may include high detection sensitivity, and that may be manufactured at low cost may be provided.

In the aforementioned embodiment, the second conductive wire 34 includes the core material 341 including the elasticity, the plural conductive wires 342 being wounded about the core material 341 in a spiral manner, and the conductive fiber 343 covering the plural conductive wires 342, which are not limited thereto. For example, any conductive wires may be applied as long as the coefficient of elasticity of the second conductive wire is lower than the first conductive wire, for example, a conductive wire being wavily meandered, or being wounded in a spiral manner, or plural conductive thin wires meshed with one another. Alternatively, the foreign object detection sensor 10 does not have to include conductive wires, and may be configured with a component having the electrode, as long as the conductivity of the conductive rubber is sufficient enough.

According to the aforementioned embodiment, the first conductive wire 24 is formed as the solid wire made of, for example, a copper, which is not limited thereto. The first conductive wire 24 may be made from any materials as long as the materials include the coefficient of elasticity higher than the coefficient of elasticity of the second conductive wire 34, the materials that may receive the tensile force applied to the molded component at the haul-off operation of the extruding molding process.

According to the aforementioned embodiment, the second conductive rubber 32 is formed as a foam body so as to include the coefficient of elasticity thereof is lower than the coefficient of elasticity of the first conductive rubber 22. Alternatively, the second electric rubber 32 may be made from a material including the coefficient of elasticity different from the first conductive rubber 22 instead of the foam body. The first conductive rubber 22 and the second conductive rubber 32 may be formed such that coefficients of the elasticity of the first conductive rubber 22 and the second conductive rubber 32 are equal, or substantially equal to each other.

According to the aforementioned embodiment, the foreign object detection sensor 10 is provided at the circumferential rim portion of the door panel 3, which is not limited thereto. The foreign object detection sensor 10 may be provided at a circumferential rim portion of the opening portion 2op of the vehicle body 2.

According to the aforementioned embodiment, the foreign object detection sensor 10 is provided at the backdoor device opening and closing the opening portion 2op provided at the rear portion of the vehicle body 2 by moving the door panel 3 (backdoor panel), which is not limited thereto. For example, the foreign object detection sensor may be provided at a sliding door apparatus opening and closing an opening portion (a gate) provided at a side portion of the vehicle body 2 by the sliding operation of a slide door panel in the front-rear direction. Alternatively, the foreign object detection sensor may be provided at a power window apparatus opening and closing an opening portion (window) provided at a side portion of the vehicle body 2 by lifting and lowering a window glass. The foreign object detection sensor may be provided at any opening and closing apparatus as long as the opening and closing apparatus opens and closes the opening portion by moving the opening and closing body in response to the drive of the actuator.

This disclosure is applicable in, for example, a manufacturing industry of a foreign object detection sensor.

According to the aforementioned embodiment, the foreign object detection sensor 10 includes the outer cover 12 formed in the longitudinal hollow shape, the outer cover 12 including the insulating property and the elasticity, the outer cover 12 including the attachment portion 14 at the outer surface, the first electrode (the first electrode wire 20) and the second electrode (the second electrode wire 30) each including the conductivity and the elasticity, the first electrode and the second electrode extending along the longitudinal direction of the outer cover 12 in a state of being spaced apart from each other inside the outer cover 12, the second electrode (the second electrode wire 30) being disposed at a position away from the attachment portion relative to the first electrode (the first electrode wire 20), the second electrode (the second electrode wire 30) including a coefficient of elasticity lower than the first electrode (the first electrode wire 20), and the first electrode (the first electrode wire 20) and the second electrode (the second electrode wire 30) detecting a foreign object by coming in contact with each other in accordance with an elastic deformation of the outer cover 12 by a pressurizing force from the foreign object.

According to the aforementioned foreign object detection sensor 10, being disposed away from the attachment portion 14, the second electrode (the second electrode wire 30) includes the coefficient of elasticity lower than the first electrode (the first electrode wire 20), the second electrode (the second electrode wire 30) may be favorably contracted and extended in accordance with the bending deformation about the first electrode (the first electrode wire 20) that serves as the center axis. Thus, for example, in a case of being mounted so as to be along with a predetermined attachment place including a corner portion, the foreign object detection sensor 10 may be easily bent and the mountability thereof may be enhanced. Because the first electrode (the first electrode wire 20) disposed in the vicinity of the attachment portion 14 includes the coefficient of elasticity greater than the second electrode (the second electrode wire 30), and may receive the tensile force when being drawn or picked up by the hauled-off device, the foreign objet detection sensor 10 may be easily manufactured by the extrusion molding method. As a result, the foreign object detection sensor 10 that has favorable mountability and that may be manufactured as low cost may be provided.

According to another aspect of the disclosure, the first electrode (the first electrode wire 20) includes the first conductive elastic body (the first conductive rubber 22) extending along the longitudinal direction of the outer cover 12, and the first conductive wire (the first conductive wire 24) embedded inside the first conductive elastic body (the first electrode rubber 22), the second electrode (the second electrode wire 30) includes the second conductive elastic body (the second electrode rubber 32) extending along the longitudinal direction of the outer cover 12, and the second conductive wire (the second conductive wire 34) embedded inside the second conductive elastic body (the second conductive rubber 32), and the second conductive wire (the second conductive wire 34) includes the coefficient of elasticity lower than the first conductive wire (the first conductive wire 24).

Accordingly, the second electrode (the second electrode wire 30) may be favorably contracted and extended in accordance with the bending of the foreign object detection sensor 10 about the first electrode (the first electrode wire 20) serving as the center axis. Furthermore, the first electrode (the first electrode wire 20) including high coefficient of elasticity may receive the tensile force when being drawn or picked up by the hauled-off device, and the foreign object detection sensor 10 may be easily manufactured by the extrusion molding method.

According to the aforementioned embodiment, the first conductive wire (the first conductive wire 24) corresponds to a solid wire extending in a same direction as an extending direction of the first conductive elastic body (the first conductive rubber 22).

Accordingly, the first conductive wire may securely receive the tensile force when being drawn or picked up by the hauled-off device.

According to the aforementioned embodiment, the second conductive elastic body (the second conductive rubber 32) includes the coefficient of elasticity lower than the first conductive elastic body (the first conductive rubber 22).

Accordingly, the second electrode (the second electrode wire 30) may be easily and elastically deformed, and the detection sensitivity of the foreign object detection sensor 10 may be enhanced.

According to the aforementioned embodiment, the second conductive elastic body (the second conductive rubber 32) corresponds to a foam body.

Accordingly, the first and second conductive elastic bodies (the first and second conductive rubbers 22, 32) may easily include the coefficients of elasticity which are different from each other.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A foreign object detection sensor, comprising:
an outer cover formed in a longitudinal hollow shape, the outer cover including an insulating property and an elasticity, the outer cover including an attachment portion at an outer surface,
a first electrode and a second electrode each including a conductivity and the elasticity, the first electrode and the second electrode extending along a longitudinal direction of the outer cover in a state of being spaced apart from each other inside the outer cover,
the second electrode being disposed at a position away from the attachment portion relative to the first electrode, the second electrode including a coefficient of elasticity lower than the first electrode, and
the first electrode and the second electrode detecting a foreign object by coming in contact with each other in accordance with an elastic deformation of the outer cover by a pressurizing force from the foreign object.

2. The foreign object detection sensor according to claim 1, wherein
the first electrode includes a first conductive elastic body extending along the longitudinal direction of the outer cover, and a first conductive wire embedded inside the first conductive elastic body,
the second electrode includes a second conductive elastic body extending along the longitudinal direction of the outer cover, and a second conductive wire embedded inside the second conductive elastic body, and
the second conductive wire includes the coefficient of elasticity lower than the first conductive wire.

3. The foreign object detection sensor according to claim 2, wherein the first conductive wire corresponds to a solid wire extending in a same direction as an extending direction of the first conductive elastic body.

4. The foreign object detection sensor according to claim 2, wherein the second conductive elastic body includes the coefficient of elasticity lower than the first conductive elastic body.

5. The foreign object detection sensor according to claim 4, wherein the second conductive elastic body corresponds to a foam body.
